(19) United States
(12) Patent Application Publication
(10) Pub. No.: US 2013/0092865 A1
(43) Pub. Date: Apr. 18, 2013

(54) Silicon Carbonate Compositions and Methods for Their Preparation and Use

(71) Applicants: William B. Carlson, Seattle, WA (US); Gregory D. Phelan, Cortland, NY (US)

(72) Inventors: William B. Carlson, Seattle, WA (US); Gregory D. Phelan, Cortland, NY (US)

(73) Assignee: EMPIRE TECHNOLOGY DEVELOPMENT LLC, Wilmington, DE (US)

(21) Appl. No.: 13/388,816

(22) PCT Filed: Oct. 12, 2011
(86) PCT No.: PCT/US11/56016

§ 371 Date: Feb. 3, 2012

(51) Int. Cl. A62D 1/02; B05D 5/00; A62D 1/00; C09K 21/02; B82Y 30/00

(52) U.S. Cl. 252/3; 252/2; 252/601; 252/604; 252/610; 427/331; 977/773; 977/902

(57) ABSTRACT

Devices, materials, and methods of preparing devices and materials including silicon carbonate (Si(CO₃)₂) as a flame retardant composition are generally disclosed. In one example, a compositions including silicon carbonate and at least one propellant are described. In another example, flame retardant materials including silicon carbonate are described. In yet another example, methods of preparing a flame retardant material are described. In a further example, fire extinguisher devices containing silicon carbonate are described.

### BACKGROUND

Unless otherwise indicated herein, the materials described in this section are not prior art to the claims in this application and are not admitted to be prior art by inclusion in this section.

Fire and other combustion processes pose possible danger for people and nature alike. When uncontrolled, fire and combustion can cause damage quickly. Many materials and devices have been developed that aim to lessen this danger. Typically, such materials and devices fall into two general groups: smothering agents and chemical inhibitors.

Smothering agents act to prevent oxygen from reaching the fire, thereby essentially “choking” the fire. Examples of smothering agents include water and phosphates, though other agents exist as well. In some cases, smothering agents may not be sufficient to control large or spreading fires. Further, many smothering agents have negative effects themselves. As an example, phosphates may prevent plant growth and can have other negative effects.

Chemical inhibitors often include chlorine or bromine and are designed to decompose homolytically, meaning a chemical bond is dissociated to form a neutral molecule and two free radicals. The radicals combine with oxygen and radicals in the combustion process to stop the combustion process. While chemical inhibitors tend to be more effective than smothering agents at controlling large or spreading fires, many chemical inhibitors also have negative effects. In particular, many chemical inhibitors may produce halogenated carbons, which may deplete the ozone layer.

### SUMMARY

Devices, materials, and methods of fabricating devices and materials including silicon carbonate (Si(CO₃)₂) as a flame retardant composition are generally disclosed. In one example, a fire extinguishing composition is described that includes silicon carbonate and at least one propellant. The silicon carbonate may be in the form of a water slurry, a foam, or a powder, for example.

In another example, a flame retardant material is described that includes a material and silicon carbonate. The material may be non-flame-retardant material, such that the addition of silicon carbonate imparts flame retardancy to the material, or the material may be a flame-retardant material, such that the addition of silicon carbonate improves flame retardancy of the material.

In yet another example, a method of manufacturing a flame retardant wood material is described. The method includes dispersing silicon carbonate in a solvent to form a mixture and applying the mixture into or onto a material.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

In the figures,

FIG. 1 illustrates an example fire extinguisher device, arranged in accordance with at least some embodiments.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Devices, materials, and methods of making and using materials including silicon carbonate (Si(CO₃)₂; CAS 1000286-59-8) as a flame retardant are disclosed. In some examples, there may be advantages to using silicon carbonate as a flame retardant composition.

Silicon dioxide can be readily prepared, and is commercially available from multiple sources. Silicon dioxide (SiO₂) is reacted with carbon dioxide (2(CO₂)) to form silicon carbonate (Si(CO₃)₂). Silicon dioxide, also known as silica, is commonly found in nature as, for example, sand or quartz. Carbon dioxide is similarly prevalent in nature and can be isolated using a number of processes including, for example, air distillation and reactions between various acids and metal carbonates. The resulting product, silicon carbonate, is a non-toxic and stable material. In addition, silicon carbonate may be a relatively inexpensive material that may be the byproduct of various other processes, such as the process of sequestering carbon dioxide from the atmosphere using quartz and other silicon dioxide materials.

Silicon carbonate can thermally decompose. Silicon carbonate can act as a flame retardant when exposed to high levels of heat. At temperatures at or above about 350° C., silicon carbonate decomposes back into silicon dioxide and carbon dioxide, the opposite reaction to the formation reaction described above. Carbon dioxide may be effective as a chemical inhibitor, while silicon dioxide may be effective as a smothering agent. Further, each of carbon dioxide and silicon dioxide is relatively non-toxic, non-corrosive, and stable. The result can be a safe and effective means of combatting or preventing fire.

Carbon dioxide is typically a gas at high temperatures. Carbon dioxide gas is heavier than oxygen, so it acts to displace oxygen around the fire, effectively “choking” the fire, as described above.

Silicon dioxide is typically a solid at high temperatures. In particular, when silicon dioxide is above its glass transition temperature of about 600° C., it may be in the form of a pumice-like solid of a macroscopic size that aids in smothering combustion.

In this manner, silicon carbonate may be used as a safe and effective flame retardant. Indeed, in experimentation silicon carbonate has proved more effective than either calcium carbonate or magnesium carbonate, both of which are commonly used as flame retardants, in a comparison of combustion suppression per unit weight. Further, silicon carbonate has proved to be relatively safe and non-toxic, unlike each of calcium carbonate and magnesium carbonate, which form metal oxides when heated that can cause burns and damage plant or animal life.

Compositions

One embodiment is directed towards compositions comprising silicon carbonate. The silicon carbonate can be present in a variety of physical forms. For example, the silicon carbonate can be present as a slurry, a foam, a solid, or a powder.

The compositions can further include at least one additional material. The additional material can be at least one propellant. The propellant can be selected to assist in moving the composition from one location to another location. For example, when a pressurized propellant is depressurized, it can assist in moving the composition from a contained space towards another location. For example, a composition containing silicon carbonate and a pressurized propellant inside a fire extinguisher device can be moved from inside the device to a location outside of the device by depressurizing the propellant and ejecting the contents through a nozzle towards a desired destination location. Propellants can be liquids, gases, compressed gases, supercritical fluids, solids that can generate gases, or other materials. Specific examples of propellants include nitrogen, carbon dioxide, argon, krypton, xenon, sulfur hexafluoride, nitrogen oxides, fluorocarbons, hydrochlorofluorocarbons, Freon, and acetone.

The additional material can be a solid. Specific examples of solids include sodium bicarbonate (NaHCO₃), potassium bicarbonate (KHCO₃), monoammonium phosphate ((NH₄)H₂PO₄), urea, potassium chloride (KCl), silica, and mixtures thereof.

Alternatively, the additional material can be at least one solvent. The silicon carbonate can be dissolved in the solvent, mixed in the solvent, or dispersed in the solvent, for example. Specific examples of solvents include water, deionized water, acetone, mineral spirits, glycerol, propylene glycol, Freon, Halon, methylene chloride, chloroform, and supercritical fluids including supercritical carbon dioxide, supercritical nitrogen, supercritical oxygen, supercritical argon and other supercritical noble gases, supercritical nitrogen oxides, supercritical methane, supercritical ethane, supercritical propane, supercritical butane, supercritical pentane, supercritical hexane, a hydrocarbon, and mixtures thereof. Other solvents are possible as well, as well as mixtures of two or more miscible or immiscible solvents.

The silicon carbonate may be present at a variety of concentrations, depending on the desired application. An example range of concentrations can be about 1% to about 50% by weight. Specific examples of concentrations include about 1% by weight, about 5% by weight, about 10% by weight, about 20% by weight, about 30% by weight, about 40% by weight, about 50% by weight, and ranges between any two of these values. Other concentrations are possible as well. For example, a “concentrate” may include silicon carbonate at a higher percentage by weight. The silicon carbonate can be evenly or unevenly present throughout the compositions. In some embodiments, the silicon carbonate may be evenly dispersed through the solvent using one or more mixing techniques, such as a physical, shaking, stirring, magnetic, or ultrasound mixing technique. Other mixing techniques are possible as well.

The silicon carbonate, when present as a solid, can be present at generally any particle size. The particle size can be substantially uniform or non-uniform. A general average particle size range can be about 20 nm to about 2500 nm. One example of an average particle size range is greater than about 100 nm. Specific examples of particle sizes include about 20 nm, about 50 nm, about 100 nm, about 200 nm, about 300 nm, about 400 nm, about 500 nm, about 600 nm, about 700 nm, about 800 nm, about 900 nm, about 1000 nm, about 1100 nm, about 1200 nm, about 1300 nm, about 1400 nm, about 1500 nm, about 1600 nm, about 1700 nm, about 1800 nm, about 1900 nm, about 2000 nm, about 2100 nm, about 2200 nm, about 2300 nm, about 2400 nm, about 2500 nm, and ranges between any two of these values.

Treated Materials and Methods of their Preparation

An additional embodiment is directed towards materials containing silicon carbonate. The presence of silicon carbonate can impart fire retardancy properties to the material, or can increase the fire retardancy property of the material relative to the same material lacking the silicon carbonate. In other words, the fire retardancy of the material containing silicon carbonate is higher than the fire retardancy of the same material lacking silicon carbonate. In some embodiments, the material lacking silicon carbonate is susceptible to fire, while the material containing silicon carbonate is substantially fire retardant. In an ideal situation, the presence of silicon carbonate can make the material substantially fireproof or fire retardant.

The silicon carbonate can be present at the surface of the material, can be present within the material, or both at the surface and within the material. The silicon carbonate can be present uniformly or non-uniformly on or within the material. In some cases, the silicon carbonate can be present at a higher concentration at the surface of the material than within the material. In other cases, the silicon carbonate can be present uniformly within the material. In some cases, the interior of the material can lack silicon carbonate, while the surface of the material contains silicon carbonate.

The material can generally be any material. Specific examples of materials include wood, wallboard, ceiling tiles, wood paneling, shingles, fabrics, plastics, foams, tile, flooring, thermal insulation, electrical insulation, containers, cartons, cardboard, lumber products, clothing, paper, leather, cotton, paint, stain, primer, trees, plants, animals, bedding, furniture, toys, games, bottles, utensils, clothing, draperies, carpets, urethane foams, acrylic foams, styrene foams, polyolefin foams, polyuria foams, acrylic fibers, styrene fibers, olefin fibers, and cellulose fibers.

The methods may include one or more operations, functions, or actions. Although the methods and steps are described in a sequential order, these steps may also be performed in parallel, and/or in a different order than those described herein. Also, the various steps may be combined into fewer steps, divided into additional steps, and/or eliminated based upon the desired implementation.

In one embodiment, a method of treating a material can include dispersing silicon carbonate in at least one solvent to prepare a mixture, and applying the mixture to a material to form a treated material. In another embodiment, a method of treating a material can include applying a first static charge to silicon carbonate, applying a second static charge opposite the first static charge to the material, and bringing the silicon carbonate close to the material to allow the opposite static charges to draw the silicon carbonate onto the material.

In embodiments where the silicon carbonate is in the form of silicon carbonate nanoparticles, the method may further include forming the silicon carbonate nanoparticles prior to preparing the mixture. This may involve, for example, a vapor-phase process in which silicon carbonate is evaporated into a gas phase and then rapidly cooled in, for example, nitrogen, causing rapid condensation of the silicon carbonate into nanoparticles. As another example, this may involve a supercritical fluid process, in which silicon carbonate is introduced into a supercritical fluid solvent and pressurized, causing rapid expansion of the supercritical fluid into a gas that pulverizes the silicon carbonate into nanoparticles. As yet another example, this may involve a large pressure or temperature change that causes rapid expansion of the silicon carbonate and, in turn, causing the formation of the silicon carbonate nanoparticles. As still another example, this may involve one or more physical techniques, such as ball milling, roll milling, and crushing between plates. Other examples are possible as well.

One example of the applying step can include injecting the mixture into the material. Various techniques may be used to inject the mixture (containing the silicon carbonate and the solvent) into the material, including both non-pressure treatments and pressure treatments. Examples of non-pressure treatments include brushing, spraying, dipping, soaking, steeping, and diffusion treatments. Examples of pressure treatments include full-cell and fluctuation pressure treatments. Pressure treatments may be scalable, allowing for relatively simple large-scale production. In addition, pressure treatments may in some cases offer greater control over the penetration and retention of the silicon carbonate, as described below. Further, pressure treatments may in some cases be more permanent treatment than non-pressure treatments.

The material may be placed in a closed chamber and exposed to the mixture containing the silicon carbonate and the solvent. Inside the chamber, a high pressure can be applied, pressurizing the chamber. The high pressure may force some or all of the silicon carbonate to penetrate the material, thereby impregnating the material. In some embodiments, a vacuum may be applied following the high pressure so as to remove any excess silicon carbonate.

Depending on the application, a concentration of silicon carbonate injected into the material may be, for example, about 1.5% to about 3% by weight. Other examples are possible as well. In general, a higher concentration of silicon carbonate in the material will increase the flame retardancy of the material. In some embodiments, the concentration of silicon carbonate may depend on the type of material (e.g., wood, plastic, etc.). For materials that are relatively more flammable, it may be desirable to use a higher concentration of silicon carbonate such as, for example, about 20% by weight. Other examples are possible as well.

An average distance to which the silicon carbonate penetrates the material may be controlled by varying the pressure applied. Similarly, an average amount of silicon carbonate retained in the material may be controlled by varying the pressure applied. Examples of pressures include pressures of about 100 atm (10.1 MPa) to about 300 atm (30.4 MPa), though other pressures are possible as well. Specific examples of pressures include about 100 atm (10.1 MPa), about 150 atm (15.2 MPa), about 200 atm (20.3 MPa), about 250 atm (25.3 MPa), about 300 atm (30.4 MPa), and ranges between any two of these values. In general, higher pressures may lead to deeper average penetration of the silicon carbonate into the material. Similarly, higher pressures may lead to higher amounts of silicon carbonate being retained in the material. Additionally, higher pressures may be required for larger average diameters of silicon carbonate.

While the foregoing discussion focused on injecting the silicon carbonate into the material, in some embodiments the mixture containing the silicon carbonate and the solvent may be used to coat the material. For example, the mixture may be used as a paint, stain, or spray coating. Other examples are possible as well.

In some embodiments, it may be desirable to include one or more additional compounds in the mixture to be applied to the material. The additional compounds may be other compounds to impart flame retardancy to the material, or the additional compounds may serve to impart other properties to the material, such as preservation or color. Example compounds that may be used to impart preservation to the material include copper, copper compounds, zinc, zinc compounds, and oxides, as well as one or more organic compounds such as borates, ammonium compounds, iazolin wood preservatives, bifenthrin preservatives, amine compounds, amide compounds, oils, tars, waxes, benzoate, ammonium compounds, phosphonium compounds, arsenic preservatives, and chromate preservatives. Other examples are possible as well.

For purposes of illustration, an example method of manufacturing a flame retardant material (such as wood) including both silicon carbonate and copper is discussed. Copper may be injected into the material to aid in preserving the material. It is to be understood, however, that a similar method could be used to manufacture a flame retardant material including both silicon carbonate and another compound.

The silicon carbonate may be in the form of silicon carbonate nanoparticles. Similarly, the copper may be in the form of copper nanoparticles. Each of the silicon carbonate nanoparticles and the copper nanoparticles may be formed using one or more of the methods described above. Each of the silicon carbonate nanoparticles and the copper nanoparticles may have an average diameter of, for example, less than about 500 nm and/or greater than about 20 nm. In some embodiments, the silicon carbonate nanoparticles and the copper nanoparticles may have the same average diameter, while in other embodiments the silicon carbonate nanoparticles may have an average diameter that is greater than or less than an average diameter of the copper nanoparticles.

The silicon carbonate and the copper may be dispersed in at least one solvent. The solvent may be any of the solvents described above. The silicon carbonate and the copper may be dispersed in the solvent at a variety of concentrations, depending on the application. An example concentration may be about 5% by weight of each of silicon carbonate and copper, though the concentration could range between, e.g., about 1% and about 50% by weight of each of silicon carbonate and copper. Specific examples of concentrations include about 1% by weight, about 5% by weight, about 10% by weight, about 20% by weight, about 30% by weight, about 40% by weight, about 50% by weight, and ranges between any two of these values. Other concentrations are possible as well. In some embodiments, the silicon carbonate and the copper may be evenly dispersed through the solvent using one or more of the mixing techniques described above.

The material may be placed in a closed chamber and exposed to the mixture containing the silicon carbonate, the copper, and the solvent. Inside the chamber, a high pressure may be applied, pressurizing the chamber. The high pressure may force some or all of the silicon carbonate and the copper to penetrate the material. In some embodiments, a vacuum may be applied following the high pressure so as to remove any excess silicon carbonate or copper. In some embodiments, the pressure may be controlled so as to, for example, create a varied concentration of silicon carbonate in the material. Other examples are possible as well.

An average distance to which the silicon carbonate and the copper penetrate the material may be controlled by varying the pressure applied. The silicon carbonate and the copper may penetrate the same average distance into the material, or one of the silicon carbonate and the copper may penetrate deeper than the other. Similarly, an average amount of silicon carbonate and an amount copper retained in the material may be controlled by varying the pressure applied. The amount of silicon carbonate retained in the material may be the same as, greater than, or less than the amount of copper retained in the material. Examples of pressures include pressures between about 100 atm (10.1 MPa) and about 300 atm (30.4 MPa), though other pressures are possible as well. Specific examples of pressures include about 100 atm (10.1 MPa), about 150 atm (15.2 MPa), about 200 atm (20.3 MPa), about 250 atm (25.3 MPa), about 300 atm (30.4 MPa), and ranges between any two of these values. In general, higher pressures may lead to deeper average penetration of each of the silicon carbonate and the copper into the material. Similarly, higher pressures may lead to higher amounts of silicon carbonate and copper being retained in the material. Additionally, higher pressures may in some cases be required for larger average diameters of silicon carbonate and copper.

One alternative example of the applying step can include applying the silicon carbonate to the surface of the material. Specific examples include brushing, spraying, dipping, soaking, steeping, and diffusion treatments.

Fire Extinguisher Devices

An additional embodiment is directed towards fire extinguisher devices. The fire extinguisher device can contain at least silicon carbonate as described above. The fire extinguisher device can contain at least one propellant as described above. The fire extinguisher device can be configured to deliver the silicon carbonate to a fire.

Due to the effective and safe nature of silicon carbonate, as well as its decomposition into both a chemical inhibitor and a smothering agent, the fire extinguisher device may be used in, for example, chemical fires, residential fires, oil and gas fires, electrical fires, and outdoor fires. Other examples are possible as well. The fire extinguisher device may be classified as suitable to treat one or more types of fires. For example, the fire extinguisher device may be classified as suitable to treat at least one of Class A, B, C, D, E, or F fires.

The fire extinguisher device can further contain at least one additional fire treatment compound. Specific examples of additional fire treatment compounds include bromo compounds, chloro compounds, boric acid, boronic acid, borane, organoborane, Halon, copper carbonate, zinc carbonate, iron carbonate, calcium carbonate, magnesium carbonate, lithium carbonate, sodium carbonate, potassium carbonate, sodium bicarbonate, potassium bicarbonate, calcium bicarbonate, magnesium bicarbonate, iron bicarbonate, copper bicarbonate, magnesium hydroxide, calcium hydroxide, iron hydroxide, copper hydroxide, zinc hydroxide, silica, silicates, silicone, sand, quartz, talc, mica, ammonium sulfate, phosphates, ammonium phosphates, phosphate ester, phosphonates, phosphinates, dimethyl methyl phosphonate, dimethyl methyl phosphonate, dimethyl methyl phosphonate, triethyl phosphate, phosphonic acid, methyl(5-methyl-2-methyl-1,3,2-dioxaphosphorinan-5-yl)methyl, methylester, P-oxide, diethyl N,N-bis(2-hydroxyethyl)amino methyl phosphonate, vinylchloride, vinylbromide, polyvinylchloride, polyvinylbromide, poly(vinylchloride-vinylbromide), vinylidene chloride, polyvinylidene chloride (Saran®), and vinylidene bromide.

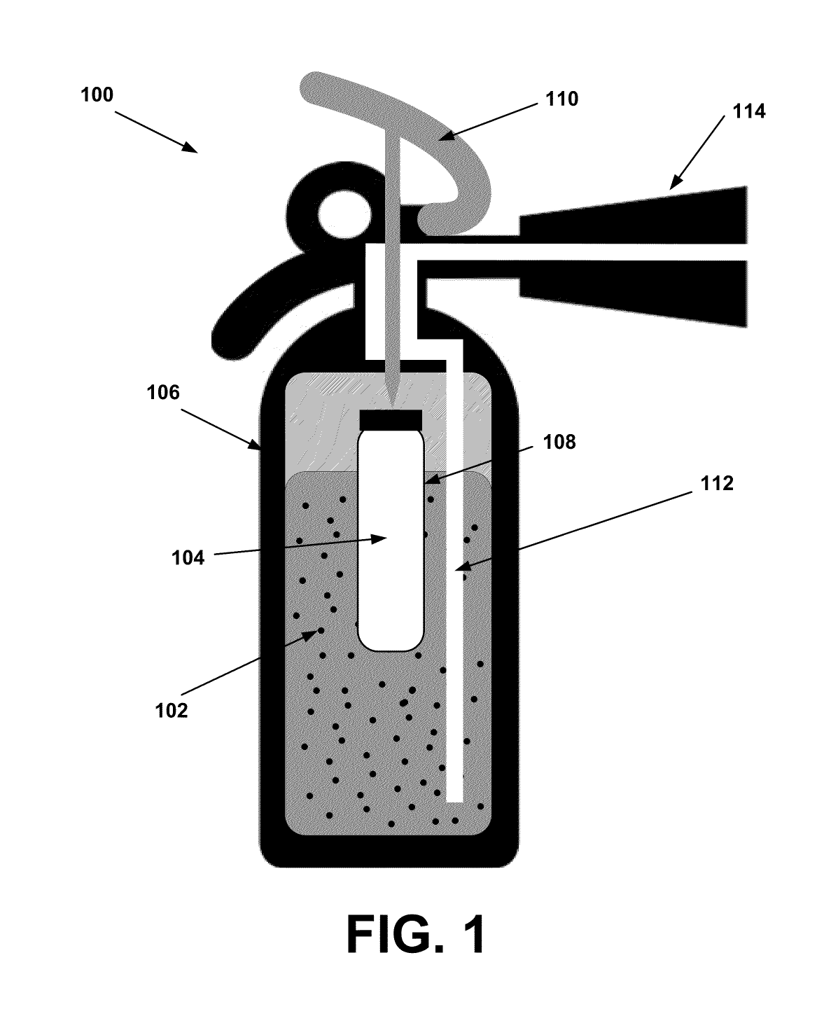

In the fire extinguisher device 100, the silicon carbonate 102 and the propellant 104 may be stored inside a closed container 106 formed of, for example, stainless steel, chromium, tungsten, aluminum, copper, nickel, cobalt, or another metal. Within the closed container 106, the silicon carbonate 102 and the propellant 104 may be pressurized at a pressure higher than ambient pressure. For example, the propellant 104 may be pressurized to, for example, about 60 atm (6.1 MPa) to about 140 atm (14.2 MPa), depending on the material used as the propellant 104. Other examples are possible as well. While the propellant 104 is shown in FIG. 1 to be stored in a container 108 separate from the silicon carbonate 102, in other embodiments the propellant 104 and the silicon carbonate 102 may be stored together.

As shown in FIG. 1, the fire extinguisher device 100 may also include at least one of a lever 110, a tube 112, and a nozzle 114. In some embodiments, the device can include at least one lever 110, at least one tube 112, and at least one nozzle 114. The device can be configured such that when the lever 110 is pressed, the silicon carbonate is pushed through the tube 112 and out the nozzle 114. In operation, when the lever 110 is pressed, the container 108 may be punctured, allowing the pressurized propellant 104 to expand out of the container 108. As the propellant 104 expands, the silicon carbonate 102 may be pushed up the tube 112 and out the nozzle 114. As described above, upon contact with temperatures at or above about 350° C., the silicon carbonate 102 may decompose into the chemical inhibitor carbon dioxide and the smothering agent silicon dioxide.

Depending on the desired application, the fire extinguisher device may contain silicon carbonate 102 and the propellant 104 in predefined relative amounts. For example, the fire extinguishing agent may include a first amount of silicon carbonate 102 and a second amount of propellant 104. A ratio of the first amount to the second amount may be predefined according to desired performance of the fire extinguisher device. In one example, the canister in which the propellant 104 is stored may be about 25% of the total volume of the fire extinguisher 100. Other examples are possible as well.

Methods of Treating Fires

An additional embodiment is directed towards methods of treating fires. The methods can include providing a composition containing silicon carbonate, and applying the composition to a fire. Any of the above described compositions can be used. Applying the composition can reduce the size or intensity of the fire. In an ideal situation, applying the composition will extinguish the fire. In some cases, applying the compositions will reduce the chance of reignition of the fire after the fire has been extinguished. In an ideal situation, applying the compositions will prevent reignition of the fire after the fire has been extinguished. In some embodiments, the above described fire extinguisher devices can be used to apply silicon carbonate to a fire.

### EXAMPLES

### Example 1

### Preparation of Silicon Carbonate Composition

In one example, a mixture can be created by dispersing silicon carbonate nanoparticles having an average diameter of 30 nm into deionized water. The concentration of silicon carbonate nanoparticles can be 5% by weight. The composition can be used to treat wood, for example.

### Example 2

### Preparation of Silicon Carbonate and Copper Composition

In another example, a mixture can be created by dispersing both silicon carbonate and copper particles, each having an average diameter of 30 nm, into deionized water. The concentration of silicon carbonate nanoparticles can be 5% by weight, and the concentration of copper nanoparticles can be 5% by weight. The composition can be used to treat wood, for example. The silicon carbonate can reduce the susceptibility of the wood to fire, and the copper can act as a wood preservative.

### Example 3

### Preparation of Fire Extinguisher Composition

In one example, a water-based slurry of silicon carbonate can be formed. 1 L of deionized water can be added to a 2 L kettle equipped with a mechanical stirring mechanism. 10.0 g of Acrysol ASE-60 thickener can be added to the deionized water, followed by a slow addition of 500 g of silicon carbonate particles having an average diameter of 50-100 μm. 5.2 mL of 28% ammonia solution can be then added, resulting in a thick water-based slurry of silicon carbonate for use in a fire extinguisher. Nitrogen or carbon dioxide could be used as a propellant.

### Example 4

### Preparation of Wet Fire Extinguisher Composition with Foaming

In another example, a wet foaming solution of silicon carbonate can be formed. 1 L of deionized water can be added to a 2 L kettle equipped with a mechanical stirring mechanism. 15.0 g of Acrysol ASE-60 thickener can be added to the deionized water, followed by a slow addition of 100 g of silicon carbonate particles having an average diameter of 500 nm. 5.2 mL of 28% ammonia solution can be then added, followed by 0.05 g of AQF-2 foaming agent, resulting in a wet foaming solution of silicon carbonate.

### Example 5

### Preparation of Dry Fire Extinguisher Composition

In yet another example, a dry powder of silicon carbonate can be formed including silicon carbonate particles having an average diameter of 50-100 μm. Nitrogen or carbon dioxide could be used as a propellant.

### Example 6

### Preparation of Dry Fire Extinguisher Composition with PVC

In still another example, a dry powder of silicon carbonate can be formed including silicon carbonate particles having an average diameter of 50-100 μm combined with a poly(vinyl chloride) thermoplastic additive. The concentration of the poly(vinyl chloride) thermoplastic additive can be 10% by weight. The poly(vinyl chloride) thermoplastic additive could act as an oxygen-excluding crust.

### Example 7

### Preparation of Multi-Agent Fire Extinguisher Composition

In yet another example, a dry powder of silicon carbonate can be formed including silicon carbonate particles having an average diameter of 50-100 μm combined with sodium bicarbonate (NaHCO₃), potassium bicarbonate (KHCO₃), and monoammonium phosphate ((NH₄)H₂PO₄). The concentrations can be as follows: silicon carbonate can be 75% by weight, monoammonium phosphate can be 15% by weight, sodium bicarbonate can be 7.5% by weight, and potassium bicarbonate can be 2.5% by weight.

### Example 8

### Preparation of Fire Extinguisher Composition with Silica

In still another example, a dry powder with absorbent materials can be formed including silicon carbonate particles having an average diameter of 50-100 μm combined with fumed silica. The concentration of the silicon carbonate can be 75% by weight, and the concentration of the fumed silica can be 25% by weight. The fumed silica could act as an absorbent material for pyrophoric materials, thereby limiting the availability of fuel.

### Example 9

### Example Performance Measurements

In one experiment, silicon carbonate can be compounded with low density polyethylene and formed into sample strips 5 mm wide and 750 mm long. The sample strips can be placed under a radiant panel inside a sample holder and ignited. The spread of the flame is visually monitored and the point where the flame is extinguished can be noted, and an incident flux at the point where the flame was extinguished, called the minimum flux for spread (MFFS) can be determined using a flux calibration curve. This process is described in detail in ASTM International Method E1321. The MMFS of the silicon carbonate/polyethylene sample strips may indicate that silicon carbonate performed at least comparably to magnesium hydroxide flame retardants and performed better than aluminum trihydrate, magnesium carbonate, calcium carbonate, and iron carbonate flame retardants.

### Example 10

### Preparation and Use of a Fire Extinguisher Device

A conventional commercial dry chemical fire extinguisher, such as one suitable for charging with sodium bicarbonate or monoammonium phosphate can be obtained. The fire extinguisher can be charged with silicon carbonate, and pressurized with nitrogen gas.

The fire extinguisher device can be used to apply the silicon carbonate to a fire, extinguishing the fire and preventing reignition.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or figures, should be understood to contemplate the possibilities of including one of the terms, either of the terms, or both terms. For example, the phrase “A or B” will be understood to include the possibilities of “A” or, “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A fire extinguishing composition comprising:
silicon carbonate (Si(CO₃)₂); and
at least one propellant.

2. The composition of claim 1, wherein the silicon carbonate is present as a slurry, a foam, a solid, or a powder.

3. The composition of claim 1, further comprising sodium bicarbonate (NaHCO₃), potassium bicarbonate (KHCO₃), monoammonium phosphate ((NH₄)H₂PO₄), or mixtures thereof.

4-5. (canceled)

6. The composition of claim 1, wherein the silicon carbonate is present at about 1% by weight to about 50% by weight.

7. The composition of claim 1, wherein the silicon carbonate has an average particle size of about 20 nm to about 2500 nm.

8. A flame retardant material comprising:
a material; and
silicon carbonate (Si(CO₃)₂) applied the material, within the material, or both.

9. The flame retardant material of claim 8, further comprising at least one of copper, a copper compound, zinc, a zinc compound, and an oxide.

10. The flame retardant material of claim 8, wherein the silicon carbonate is present as silicon carbonate nanoparticles.

11. The flame retardant material of claim 8, wherein the flame retardant material has a higher fire retardancy than the same material lacking silicon carbonate.

12. (canceled)

13. The flame retardant material of claim 8, wherein the silicon carbonate is present as silicon carbonate nanoparticles having an average diameter of about 20 nm to about 2500 nm.

14. The flame retardant material of claim 8, wherein the silicon carbonate is substantially uniformly dispersed within the material.

15. (canceled)

16. A method of preparing a flame retardant material, the method comprising:
dispersing silicon carbonate (Si(CO₃)₂) in a solvent to form a mixture; and
applying the mixture into or onto a material to make a flame retardant material.

17. (canceled)

18. The method of claim 16, wherein the silicon carbonate is present as silicon carbonate nanoparticles.

19. The method of claim 16, wherein the silicon carbonate is present as silicon carbonate nanoparticles having an average diameter of about 20 nm to about 2500 nm.

20. The method of claim 16, wherein the applying step comprises performing a pressure treatment to the material.

21. The method of claim 16, wherein the applying step comprises injecting the silicon carbonate to penetrate a first average distance into the material.

22. The method of claim 21, wherein
the first average distance is based at least in part on a pressure at which the applying is performed.

23. The method of claim 16, wherein the applying step comprises applying at a pressure of about 100 atm (10.1 MPa) to about 300 atm (30.4 MPa).

24. The method of claim 16, wherein the applying step comprises brushing, spraying, dipping, soaking, steeping, and diffusion treatments to the surface of the material.

25. A fire extinguisher device comprising a closed container storing silicon carbonate and at least one propellant.

26-27. (canceled)

28. The device of claim 25, further comprising at least one of a lever, a tube, and a nozzle.

29. (canceled)

30. The device of claim 25, pressurized to a pressure higher than ambient pressure.

31. The device of claim 25, pressurized to about 60 atm (6.1 MPa) to about 140 atm (14.2 MPa).

32. The device of claim 25, wherein the silicon carbonate is present separate from the propellant.

33-38. (canceled)
